(19) United States
(12) Patent Application Publication
(10) Pub. No.: US 2014/0101043 A1
(43) Pub. Date: Apr. 10, 2014

(54) Sound-Based Payment Transactions

(71) Applicant: BANK OF AMERICA CORPORATION, Charlotte, NC (US)

(72) Inventor: Matthew Brian Cincera, Charlotte, NC (US)

(73) Assignee: Bank of America Corporation, Charlotte, NC (US)

(21) Appl. No.: 13/646,804

(22) Filed: Oct. 8, 2012

(51) Int. Cl. G06Q 40/00

(52) U.S. Cl. 705/44

(57) ABSTRACT

According to an embodiment, a payment is facilitated though sound-based communication. A first sound-based communication is received. The first sound-based communication is received over a local network that is distinct from a general communications network. The method determines that the first sound-based communication comprises an entity identifier. Entity data comprising a plurality of entities is accessed. The method determines that the plurality of authorized entities comprises an entity associated with the entity identifier. The method determines that the entity associated with the entity identifier is authorized to participate in sound-based payment transactions. A second sound-based communication is transmitted authorizing a payment of a payment amount to the entity. The second sound-based communication is transmitted over the local network that is distinct from the general communications network.

### TECHNICAL FIELD OF THE INVENTION

This invention relates, in general, to facilitation of transactions and, more particularly, to facilitation of sound-based payment transactions.

### BACKGROUND OF THE INVENTION

Retailers provide many goods and services for purchase by individuals at retail locations. Individuals may have various options for purchasing these good and services, the most basic of which is cash. Individuals may not want to carry cash for completing payment transactions. Additionally, other available options for completing payment transactions may be unavailable, unreliable, and/or inconvenient.

### SUMMARY OF THE INVENTION

In accordance with the present invention, disadvantages and problems associated with facilitating payment transactions may be reduced or eliminated.

According to one embodiment of the present invention, a payment is facilitated though sound-based communication. A first sound-based communication is received. The first sound-based communication is received over a local network that is distinct from a general communications network. The method determines that the first sound-based communication comprises an entity identifier. Entity data comprising a plurality of entities is accessed. The method determines that the plurality of authorized entities comprises an entity associated with the entity identifier. The method determines that the entity associated with the entity identifier is authorized to participate in sound-based payment transactions. A second sound-based communication is transmitted authorizing a payment of a payment amount to the entity. The second sound-based communication is transmitted over the local network that is distinct from the general communications network.

Certain embodiments of the invention may provide one or more technical advantages. A technical advantage of one embodiment allows for payment of goods/services using sound-based communication. Other communication methods (e.g., cellular) may be less reliable inside of a building where transactions for goods and/or services may occur. Another technical advantage of an embodiment allows a user to use a speaker and/or a microphone of a device for both speaking to other users through phone conversation and for sound-based payment transactions. Another technical advantage of an embodiment allows a user of a device to rely on entities pre-authorized to participate in sound-based payment transactions. The pre-authorized entities may be stored in a user's mobile or other device. The listing of pre-authorized entities may be provided by an administrator of an account that contains the user's funds. Another technical advantage of an embodiment allows a user to approve the amount for individual transactions paid through sound-based communication.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system operable to facilitate payment for goods and/or services through sound-based communication.

FIG. 2 illustrates an example flow chart for facilitating payment for goods and/or services through sound-based communication.

### DETAILED DESCRIPTION OF THE INVENTION

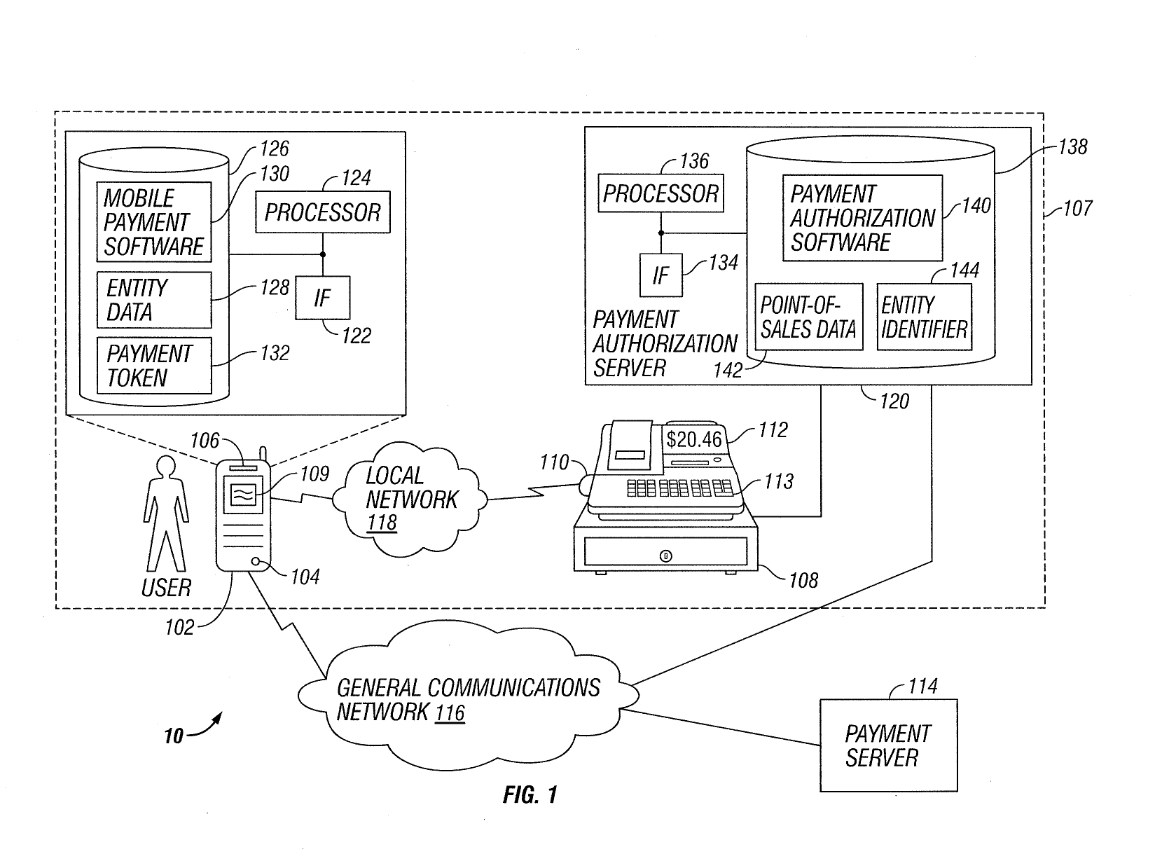

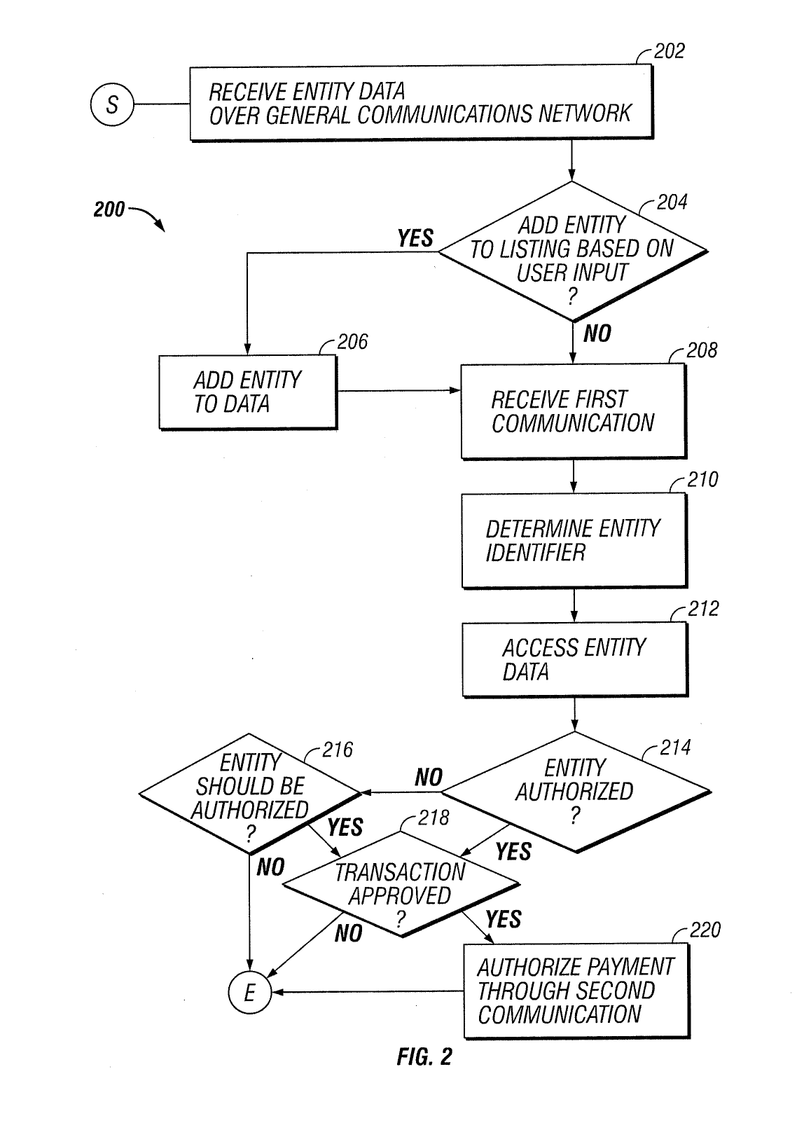

Embodiments of the present invention and its advantages are best understood by referring to FIGS. 1 and 2, like numerals being used for like and corresponding parts of the various drawings.

FIG. 1 illustrates a system 10 operable to facilitate payment for goods and/or services through sound-based communication. Certain embodiments of system 10 include a device 102 and a point-of-sales terminal 108 located at a physical premises 107 associated with an entity. Components of system 10 may allow a user of device 102 to initiate a payment transaction for goods/services provided by an entity associated with physical premises 107. Communication between mobile device 102 and point-of-sales terminal 108 may occur via communication over a local network 118 that may be principally located at physical premises 107. Local network 118 may be distinct from a general communications network 116. A payment authorization server 120 communicatively coupled to point-of-sales terminal 108 may communicate with payment server 114 to authorize payment from an account associated with a user of device 102. Payment server 114 may authorize payment and transfer funds as necessary to complete a transaction.

Device 102 may comprise any type of mobile computing device operable to manage payment transactions and communicate with the various components of system 10. In particular embodiments, device 102 allows a user to access accounts owned by the user and initiate actions associated with the accounts. Examples of devices 102 include a mobile phone, personal digital assistant, portable media player (e.g., portable video player, digital audio player, etc.), laptop, netbook, ultrabook, tablet, and/or any other suitable device. Devices 102 include any necessary hardware and software suitable to carry out their functions. Certain embodiments of device 102 include a network interface 122, a processor 124, a memory 126, a microphone 104, a speaker 106, and a graphical user interface (“GUI”) 109.

Network interface 122 represents any suitable device operable to receive information from network 116 and/or local network 118, perform suitable processing of the information, communicate to other devices, or any suitable combination of the preceding. For example, network interface 122 may receive information regarding entities authorized to receive payment from payment server 114 over general communications network 116. Network interface 122 represents any port or connection, real or virtual, including any suitable hardware and/or software, including protocol conversion and data processing capabilities, to communicate through a local area network (LAN), a wide area network (WAN), or other communication systems that allows device 102 to communicate with suitable components of system 10, such as payment server 114 and/or point-of-sales terminal 108.

Processor 124 communicatively couples to network interface 112 and memory 116. Processor 124 controls the operation and administration of device 106 by processing information received from network interface 112 and memory 116. Processor 124 includes any hardware and/or software that operates to control and process information. For example, processor 124 executes mobile payment software 130 to control the operation of device 102. Processor 124 may be a programmable logic device, a microcontroller, a microprocessor, any suitable processing device, or any suitable combination of the preceding.

Memory 126 stores, either permanently or temporarily, data, operational software, rules, or other information used by processor 124. Memory 126 includes any one or a combination of volatile or nonvolatile local or remote devices suitable for storing information, such as a non-transitory computer readable storage medium. For example, memory 126 may include random access memory (RAM), read only memory (ROM), magnetic storage devices, optical storage devices, or any other suitable information storage device or a combination of these devices. While illustrated as including particular modules, memory 126 may include any suitable information for use in the operation of device 102.

In certain embodiments, memory 126 includes entity data 128. Entity data 128 includes any rules and/or data associated with any entities to which sound-based payments possibly may be made. For example, entity data 128 may include a data structure that associates a particular entity with a certain entity code. Entity data 128 may also include an association between the entities and other information, such as the entities' complete names, addresses, phone numbers, and/or any other suitable information. In certain embodiments, entity data 128 also includes a flag that indicates whether a certain entity is or is not authorized to receive payment via sound-based communications. In alternative embodiments, an entity may be assumed to be authorized by virtue of being included in entity data 128.

Additionally, memory 126 may include any suitable software to carry out the functions of device 102. For example, devices 102 may run any suitable operating system such as WINDOWS, MAC-OS, UNIX, LINUX, iOS, Windows Mobile, Android, and/or any other suitable operating system. Devices 102 may also include any suitable native applications, such as a web browser application, a messaging application, and/or a natively-installed client application configured to carry out the functions of devices 102. For example, a user of a device 102 may use an account manager application natively installed on device 102 to facilitate making payments for goods and/or services to an entity associated with physical premises 107. Certain embodiments of memory 126 include mobile payment software 130.

Mobile payment software 124 represents any suitable set of instructions, logic, or code embodied in a non-transitory, computer readable medium and operable to facilitate transacting payments using device 102. For example, in particular embodiments, mobile payment software 124 may control a graphical user interface (“GUI”) 109 that appears on a display of device 102.

GUI 109 displays information associated with payment transactions. GUI 109 receives information from point-of-sales terminal 108, payment server 114, from the user, and/or from any other suitable source. GUI 109 is generally operable to tailor and filter data entered by and presented to the user. GUI 109 may provide the user with an efficient and user-friendly presentation of information. For example, GUI 109 may display information associated with a user account and provide options for actions associated with the account, such as approving and/or configuring a payment transaction. For example, when point-of-sales terminal 108 communicates an entity code 108 to access device 102, GUI 109 may display a prompt that asks the user whether a payment through point-of-sales terminal 108 is approved. GUI 109 may comprise a plurality of displays having interactive fields, pull-down lists, and buttons operated by the user. GUI 109 may include multiple levels of abstraction including groupings and boundaries. It should be understood that the term GUI may be used in the singular or in the plural to describe one or more GUIs and each of the displays of a particular GUI 109.

GUI 109 may be displayed to a user using a web browser that allows a user of device 102 to interact with a website, communicatively coupled to payment server 114, for example. GUI 109 may facilitate transmission and/or receipt of information from the website. Suitable web browsers may include Microsoft Internet Explorer®, Mozilla Firefox®, Google Chrome™, Apple Safari™, or Opera®. In certain embodiments, GUI 109 may be displayed using an application natively installed on each of access devices 102. For example, an enterprise associated with payment server 114 may create and distribute mobile payment software compatible with the hardware and software platform of device 102 that operates outside of a web browser. A user may install the mobile payment software on an access device and interact with the GUI provided by the mobile payment software to communicate with point-of-sales terminal 108 and/or payment server 114.

Mobile payment software 130 may include logic and/or rules for storing information in entity data 128. For example, mobile payment software 130 may instruct device 102 to retrieve information associated with entities from payment server 114. These rules may be updated periodically according to a predetermined schedule, at the request of the user, based on a trigger (e.g., detection of an ultrasonic communication, etc.), at any other suitable time, and/or according to any suitable combination of the preceding. The information for storing in entity data 128 may be received using general communications network 116. As another example, a user of device 106 may add another entity using suitable controls of GUI 109. The user may want to make a payment to an entity not listed in entity data 128. Upon prompting from GUI 109, the user may enter entity name, entity code, entity address, and/or any other suitable information associated with an entity. A user of device 102 may use such a feature to initiate person-to-person transactions with another user that has a different device 102 using sound-based communication. In certain embodiments, device 102 may be set to a “capture entity” mode, whereby entity information is transmitted from point-of-sales terminal 108 and/or another source using sound-based communication for storing in entity data 128. The detected information may be displayed to a user of device 102 using GUI 109 before the entity information is actually stored in entity data 128. In particular embodiments, the user may be prohibited from adding entities to entity data 128, such that payments may only be made to entities pre-authorized and/or known by payment server 114.

Mobile payment software 130 may also include logic and/or rules specifying how device 102 communicates with point-of-sales terminal 108. For example, device 102 may communicate with point-of-sales terminal 108 using sound-based communication. In certain embodiments, device 102 communicates with point-of-sales terminal 108 in the ultrasonic frequency range, such that the sounds transmitted and/or received are not in the range of human hearing. Access device 102 may detect sound-based communication transmitted by point-of-sales terminal 108 using microphone 104. Access device 102 may transmit sound-based communication using speaker 106. In certain embodiments, microphone 104 and speaker 106 are the same hardware that a user of device 102 uses to communicate with another person in a telephone conversation. In some embodiments, mobile payment software 130 may specify that sound-based communication with point-of-sales terminal 108 occurs with microphone 104 and/or speaker 106 while a user uses device 102 to participate in a conversation with another person, also using microphone 104 and/or speaker 106. Speaker 106 and microphone 104, in particular embodiments, may be combined into one transceiver widget.

Upon detection of a sound-based communication from point-of-sales terminal 108, mobile payment software 130 may instruct device 102 to extract an entity identifier, such as an entity code. Once an entity code has been extracted, mobile payment software 130 may specify that entity data 128 must be accessed to determine whether a record exists with an entity code that matches the entity code provided in the sound-based communication. If such a record exists, mobile payment software 130 may specify that a prompt be shown to the user of device 102 requesting approval for the transaction. The prompt may include other identifying information associated with the entity as specified in entity data 128. In certain embodiments, the sound-based communication from point-of-sales terminal 108 may include additional information, such as the amount of the bill and/or a specific point-of-sales terminal identifier. In such cases, GUI 109 may display a prompt similar to “Register <REG#> at Retailer <ENTITY-NAME> located at <ENTITY-ADDRESS> has presented a bill to you of $<BILL-AMOUNT>. Would you like to make this payment?” The entity name and entity address may be retrieved from entity data 128 based on the entity code provided in the communication from point-of-sales terminal 108. The register number (i.e., the identifier associated with point-of-sales terminal 108) and bill amount may be included in a communication received from point-of-sales terminal 108. The point-of-sales identifier included in the prompt may help to distinguish among multiple point-of-sales terminals 108 located at physical premises 107. The user may indicate approval or non-approval using a suitable control on GUI 109.

If the user indicates approval of the payment, mobile payment software 130 may specify that a payment token 132 be communicated to point-of-sales terminal 108. Payment token 132 may represent an identifier associated with an account that has funds suitable to pay for the bill presented by point-of-sales terminal 108. In certain embodiments, mobile payment software 130 may combine payment token 132 and the amount of the bill according to a suitable algorithm. The result of this algorithm may be communicated to point-of-sales terminal 108. The algorithm, for example, may be known only to payment server 114, such that the payment token 132 may not be derived by other components of system 10 or other devices located at physical premises 107.

Local network 118 represents any suitable network that facilitates sound-based communication between device 102 and point-of-sales terminal 108. Local network 118 may be principally located at physical premises 107. Local network 118 may include any interconnecting system capable of transmitting audio, such as signal enhancers and/or extenders. In certain embodiments, device 102 and point-of-sales terminal 108 are close enough in proximity such that no other equipment is required to complete communications between device 102 and point-of-sales terminal 108. In certain embodiments, system 10 is configured such that communications between access device 106 and point-of-sales terminal 108 only occur over local network 118 and not over general communications network 116.

General communications network 116 represents any suitable network that facilitates communication between the components of system 10. General communications network 116 may include any interconnecting system capable of transmitting audio, video, signals, data, messages, or any combination of the preceding. General communications network 116 may comprise all or a portion of one or more of the following: a public switched telephone network (PSTN), a public or private data network, a LAN, a metropolitan area network (MAN), a WAN, a local, regional, or global communication or computer network such as the Internet, a wireline or wireless network, an enterprise intranet, other suitable communication link, any other suitable communication link, including combinations thereof operable to facilitate communication between the components of system 10.

Point-of-sales terminal 108 represents any suitable hardware and/or software capable of processing a financial transaction. As non-limiting examples, point-of-sales terminal 108 may be a cash register, an automated kiosk, a mobile device similar to device 102, a desktop computer, another computing device, and/or any suitable combination of the preceding.

Point-of-sales terminal 108 includes any necessary hardware and software suitable to carry out its functions. For example, point-of-sales terminal 108 may include a processor similar to processor 124 for executing routines associated with facilitating payment transactions. A processor included in point-of-sales terminal 108 may comprise a programmable logic device, a microcontroller, a microprocessor, any suitable processing device, or any suitable combination of the preceding. Point-of-sales terminal 108 may also include a memory similar to memory 126 for storing software and data related to those software programs. For example, a memory included in point-of-sales terminal 108 may store an identifier representing point-of-sales terminal 108, an identifier representing an entity associated with physical premises 107, and/or any other suitable information. Where appropriate, point-of-sales terminal 108 may include a network interface similar to network interface 122 to implement the communication protocols to allow point-of-sales terminal 108 to communicate with the other components of system 10.

A physical premises 107 associated with an entity may include any suitable number of point-of-sales terminals 108 operable to process payments by devices 102. Point-of-sales terminal 108 may be used by an operator associated with the entity that provides goods and/or services to the user of device 102. Point-of-sales terminal 108 may include a display 112 operable to display an amount owed by a user of device 102 to purchases goods and/or services. Point-of-sales terminal 108 may also include a request payment button 113.

When an operator presses request payment button 113, point-of-sales terminal 108 may transmit a sound-based communication to device 102. The sound-based communication includes an entity code of the entity associated with physical premises 107. The sound-based communication may also include a point-of-sales terminal identifier, an amount owed, and any other suitable information. Point-of-sales terminal 108 may transmit the sound-based communication using transceiver 110.

Transceiver 110 is operable to communicate with device 102 using sound-based communication. Transceiver 110 may transmit and receive sound-based communications using any suitable protocol and frequency range. For example, transceiver 110 may communicate with device 102 using ultrasonic frequencies. Such sounds may be imperceptible to human hearing. In particular embodiments, transceiver 110 is a combination of a speaker apparatus and a microphone apparatus.

When transceiver 110 detects that device 102 has provided payment token 132, point-of-sales terminal 108 provides payment token 132 to a payment authorization server 120 communicatively coupled to point-of-sales terminal 108. Point-of-sales terminal 108 and payment authorization server 120 may be coupled using wired, wireless, and/or any other suitable communication link. In particular embodiments, point-of-sales terminal 108 also provides payment authorization server 120 with an amount of the purchase price, a point-of-sales terminal identifier, and/or any other suitable information.

Payment authorization server 120 may include a network server, any suitable remote server, a mainframe, a host computer, a workstation, a web server, a personal computer, a file, server, or any other suitable device operable to authorize a payment by device 102. In some embodiments, payment authorization server 120 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of payment authorization server 120 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In certain embodiments, payment authorization server 120 includes a network interface 134, a processor 136, and a memory 138.

Network interface 134 represents any suitable device operable to receive information from point-of-sales terminal 108 and/or general communications network 108, perform suitable processing of the information, communicate to other devices, or any combination of the preceding. For example, network interface 134 may communicate with payment server 114 to initiate a payment transaction for goods and/or services provided to the use of device 102. Network interface 134 represents any port or connection, real or virtual, including any suitable hardware and/or software, including protocol conversion and data processing capabilities, to communicate through a LAN, WAN, or other communication systems that allows payment authorization server 120 to exchange information with the other components of system 10.

Processor 136 communicatively couples to network interface 134 and memory 138. Processor 136 controls the operation and administration of payment authorization server 120 by processing information received from network interface 134 and memory 138. Processor 136 includes any hardware and/or software that operates to control and process information. For example, processor 136 executes payment authorization software 140 to control the operation of payment authorization server 120. Processor 136 may be a programmable logic device, a microcontroller, a microprocessor, any suitable processing device, or any suitable combination of the preceding.

Memory 138 stores, either permanently or temporarily, data, operational software, or other information for processor 136. Memory 138 includes any one or a combination of volatile or nonvolatile local or remote devices suitable for storing information. For example, memory 138 may include RAM, ROM, magnetic storage devices, optical storage devices, or any other suitable information storage device or a combination of these devices. While illustrated as including particular modules, memory 138 may include any suitable information for use in the operation of payment authorization server 120.

In certain embodiments, memory 138 includes payment authorization software 140, point-of-sales data 142, and entity identifier 144. Point-of-sales data 126 includes any rules and/or data associated with point-of-sales terminals 108 communicatively coupled to payment authorization server 138. For example, point-of-sales data 126 may store identifiers for each point-of-sales terminal 106 communicatively coupled to payment authorization server 138. Entity identifier 144 may store an identifier unique to an entity associated with physical premises 107.

Entity identifier 144 may comprise an entity code unique to the entity associated with physical premises 107.

Payment authorization software 124 represents any suitable set of instructions, logic, or code embodied in a non-transitory, computer readable medium and operable to facilitate the operation of payment authorization server 120. For example, payment authorization software 124 may include application files sufficient when executed to determine whether a payment token 132 received from point-of-sales terminal 108 is in a suitable format for communicating to payment server 114 to authorize a payment transaction. Payment authorization software 124 may reference information stored in point-of-sales data 142. For example, when point-of-sales terminal 108 presents a payment token 132 to payment authorization server 138, point-of-sales terminal 108 may also provide an identifier associated with point-of-sales terminal 108. Payment authorization software 124 may check point-of-sales data 142 for the identifier to ensure that point-of-sales terminal 108 is valid. Payment authorization software 124 may also specify that payment token 132, a sales amount, entity identifier 144, and/or any other suitable information should be communicated to payment server 144 to initiate a payment transaction. Payment authorization server 120 may receive the result of the attempted transactions (e.g., approved, declined, etc.) from payment server 114. Any suitable portion of this information may be communicated to point-of-sales terminal 108. The result may be shown on display 112.

Payment server 114 includes any suitable combination of components that operate to facilitate payment transactions. Payment server 114 may be able to manipulate, access, and/or report on accounts associated with payment token 132 and/or the entity associated with physical premises 107. Payment server 114 may include the computing systems controlled by a financial institution, such as a bank.

Payment server 114 may manage any suitable account. For example, payment server 114 may have direct control over a checking account, a savings account, a brokerage account, a loan account, a credit card account, and/or any other suitable account.

Payment server 114 may include a network server, any suitable remote server, a mainframe, a host computer, a workstation, a web server, a personal computer, a file, server, or any other suitable device operable to facilitate processing of payment transactions. In some embodiments, payment server 114 may execute any suitable operating system such as IBM's zSeries/Operating system (z/OS), MS-DOS, PC-DOS, MAC-OS, WINDOWS, UNIX, OPenVMS, Linux, iOS, Android, and/or any other appropriate operating systems, including operating systems developed in the future. The functions of payment server 114 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Additionally, payment server 114 may include a network interface, processor, and memory similar to the network interfaces, processors, and memories provided on device 102, point-of-sales terminal 108, and/or payment authorization server 120.

Payment server 114 may include software embodied on a non-transitory computer readable medium operable to interact with device 102 and payment authorization server 120. For example, payment server 114 may communicate with device 102 to provide updates on entities stored in entity data 128. Entity updates may be provided according to a predetermined schedule, when requested by device 102, automatically in response to a trigger (e.g., addition of a new entity capable of conducting sound-based payment), and/or at any other suitable time.

Payment server 114 may also receive from payment authorization server 120 payment token 132, entity identifier 144, a sales price, and/or any other suitable information that may be used to process a payment from a user of device 102 to the entity associated with physical premises 107. Payment server 114 may carry out the funds transfer in any suitable manner. In certain embodiments, payment server 114 checks an account associated with the payment token 132, determines whether the account has enough funds/credit to cover the sales price, deducts the amount of the sales price from the account associated with payment token 132, and credits an amount equal to the sales price to an account associated with the entity associated with physical premises 107. If the account associated with payment token 132 does not have enough funds/credit to cover the sales price, the sales transaction may fail. Payment server 114 may communicate the result of the attempted transaction to payment authorization server 120.

In an exemplary embodiment of operation of system 10, a user of device 102 enters physical premises 107 that is a retailer location. The user of device 102 gathers several items for purchase and takes them to point-of-sales terminal 108. Point-of-sales terminal 108 calculates a total sales price for the items desired for purchase. An amount of $20.46 is shown on display 112. Device 102 is put into a mode operable to detect sound-based communications associated with payment transactions, for example, by invoking mobile payment software 130.

Point-of-sales terminal 108 communicates an entity code, point-of-sales identifier, and an amount of the sales price to device 102 using ultrasonic communication. Device 102 extracts the entity code from the sound-based communication and determines that the entity code is listed in entity data 128. Device 102 accesses the entity name and entity address associated with the entity code from entity data. Device 102 displays a prompt on GUI 109 asking the user whether the payment of the sales amount to point-of-sales terminal 108 is approved. The user may verify the sales amount and/or the identifier associated with point-of-sales terminal 108 by checking display 112 and/or by asking an operator of point-of-sales terminal 108. The user approves the transaction, and, in response, device 102 communicates payment token 132 to point-of-sales terminal 108 using a sound-based communication. Device 102 and point-of-sales terminal 108 use local network 118 for the sound-based communications and do not use general communications network 116.

Point-of-sales terminal 108 communicates payment token 132 to payment authorization server 120 along with the identifier associated with point-of-sales terminal 108. Payment authorization server 120 verifies that point-of-sales terminal 108 is a valid terminal by comparing the provided identifier with information stored in point-of-sales data 142. Upon finding that this is a valid identifier, payment authorization server 120 communicates payment token 132, entity identifier 144, and the sales amount to payment server 114 to initiate the payment transaction. Payment server 114 accesses an account associated with payment token 114 and transfers an amount equal to the sales price to an account associated with the entity.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, point-of-sales terminal 108 may use general communications network 116 to communicate an entity code to device 102 as a secondary means of communication should communication over local network 118 fail. Likewise, device 102 may use general communications network 116 to communicate a payment token to point-of-sales terminal 108 as a secondary means of communication should communication over local network 118 fail. In some embodiments, the secondary network would be a network local to physical premises 107 that is also distinct from general communications network 116, such as a local Wi-Fi or Bluetooth network. As another example, the sales price does not have to be provided in the sound-based communication. The user may enter an amount directly into GUI 109 as the amount that should be deducted from the account associated with payment token 132. This amount may be transmitted separately from payment token 132. Alternatively, payment token 132 and the amount to be deducted may be combined according to a predetermined algorithm. Furthermore, the components of system 10 may be integrated or separated. For example, some embodiments of account status server 110 may include account database 112.

FIG. 2 illustrates an example method 200 for facilitating payment through sound-based communication. The method begins at step 202, where an entity listing is received over a general communications network. In certain embodiments, if an entity is included in the entity listing, that entity is assumed to be authorized to participate in payment transactions using sound-based communication. At step 204, the method determines whether a user wants to add an additional entity to the listing using a GUI on a device. If so, the entity is added at step 206. If not, the method proceeds to step 208, where a sound-based communication is received on a device from a point-of-sales terminal. The sound-based communication may be received over a local network that is distinct and generally inaccessible from the general communications network. The device, in certain embodiments, may be in a “listening mode” automatically activated when an application associated with mobile, sound-based transactions is invoked on the device. The sound-based communication may be received using a microphone apparatus of a mobile device.

At step 210, an entity identifier, such as an entity code, is extracted from the sound-based communication. At step 212, entity data on the device is accessed to determine whether the entity associated with the entity identifier is authorized to participate in sound-based payment transactions. At step 214, the method determines whether the entity is authorized. In certain embodiments, the entity is assumed to be authorized by virtue of being included in the entity data on the device. In alternative embodiments, the entity data may include a flag specifying whether the entity is authorized to receive a payment. If the entity is not authorized, the method proceeds to step 216, where it is determined whether the entity should be authorized. This may be determined, for example, by downloading an update of authorized entities from a payment server. As another example, the device may provide prompts to a user on a GUI asking whether the entity should be authorized. If the entity should be authorized, the entity may be added to entity data on the device similar to step 206. If the entity should not be authorized, the method may end.

If the result of step 216 is that the entity should be authorized and/or the result of the step 214 is that the entity already is authorized, the method proceeds to step 218. At step 218, it is determined whether the transaction is approved. This may be determined by prompting the user of the device for approval. If the user approves the transaction, the device sends a payment token to the point-of-sales terminal at step 220. The point-of-sales terminal may send the payment token along with the sales price to an appropriate payment server for transfer of the funds from an account associated with the payment token to an account associated with the entity. The second communication including the payment token may be transmitted on a local network that is distinct and generally inaccessible form a general communications network. The second communication, in certain embodiments, may be transmitted using a speaker apparatus of a mobile device. Following step 220, the method may end.

Modifications, additions, or omissions may be made to method 200 disclosed herein without departing from the scope of the invention. The methods may include more, fewer, or other steps. For example, at step 208 any suitable information may be received in the first and/or subsequent communications from the point-of-sales terminal. For example, the point-of-sales terminal may transmit the payment amount, an identifier associated with the particular point-of-sales terminal, and/or any other suitable information. Furthermore, at step 218, certain transactions may be pre-approved. For example, transactions involving payments to a certain subset of the entities included in the entity data may be pre-approved. As another example, transactions lower than a certain threshold may be pre-approved. Pre-approved transactions may not require that the user provide manual approval through the GUI on the device. Additionally, steps may be performed in parallel or in any suitable order.

Certain embodiments of the invention may provide one or more technical advantages. A technical advantage of one embodiment allows for payment of goods/services using sound-based communication. Other communication methods (e.g., cellular) may be less reliable inside of a building where transactions for goods and/or services may occur. Another technical advantage of an embodiment allows a user to use a speaker and microphone of a device for both speaking to other users through phone conversation and for sound-based payment transactions. Another technical advantage of an embodiment allows a user of a device to rely on entities pre-authorized to participate in sound-based payment transactions. The pre-authorized entities may be stored in a user's mobile or other device. The listing of pre-authorized entities may be provided by an administrator of an account that contains the user's funds. Another technical advantage of an embodiment allows a user to approve the amount for individual transactions paid through sound-based communication.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A device for facilitating payment through sound-based communication comprising:
a memory comprising rules for facilitating payments through sound-based communication;
a transceiver operable to transmit and receive sound based communications; and
a processor communicatively coupled to the memory and operable to:
instruct the transceiver to receive a first sound-based communication, wherein the first sound-based communication is received over a local network that is distinct from a general communications network;
determine that the first sound-based communication comprises an entity identifier;
access entity data comprising a plurality of entities;
determine that the plurality of entities comprises an entity associated with the entity identifier;
determine that the entity associated with the entity identifier is authorized to participate in sound-based payment transactions; and
instruct the transceiver to transmit a second sound-based communication authorizing a payment of a payment amount to the entity, wherein the second sound-based communication is transmitted over the local network that is distinct from the general communications network.

2. The device of claim 1, wherein the first sound-based communication and the second sound-based communication comprise ultrasonic communications.

3. The device of claim 1, the processor further operable to:
receive an update for the entity data via the general communications network; and
store information from the update in the entity data.

4. The device of claim 1, wherein the transceiver comprises a microphone and a speaker, and further wherein the microphone is operable to receive the first sound-based communication and the speaker is operable to transmit the second sound-based communication.

5. The device of claim 1, wherein the first sound-based communication further comprises an identifier that is associated with a point-of-sales terminal situated at a physical premises associated with the entity.

6. The device of claim 1, the processor further operable to present a message on a graphical user interface of the device inquiring as to whether the payment should be made to the entity.

7. The device of claim 1, the processor further operable to invoke a native application on the device that causes the device to enter a listening mode automatically when the native application is opened, such that the device operates to detect the first sound-based communication when transmitted.

8. The device of claim 1, the processor further operable to:
receive input associated with the entity from a user prior to receiving the first sound-based communication; and
add the input associated with the entity to the plurality of entities in the entity data.

9. A method for facilitating payment though sound-based communication, comprising:
receiving a first sound-based communication, wherein the first sound-based communication is received over a local network that is distinct from a general communications network;
determining, using a processor, that the first sound-based communication comprises an entity identifier;
accessing entity data comprising a plurality of entities;
determining, using the processor, that the plurality of entities comprises an entity associated with the entity identifier;
determining, using the processor, that the entity associated with the entity identifier is authorized to participate in sound-based payment transactions; and
transmitting a second sound-based communication authorizing a payment of a payment amount to the entity, wherein the second sound-based communication is transmitted over the local network that is distinct from the general communications network.

10. The method of claim 9, wherein the first sound-based communication and the second sound-based communication comprise ultrasonic communications.

11. The method of claim 9, further comprising:
receiving an update for the entity data via the general communications network; and
storing information from the update in the entity data.

12. The method of claim 9, wherein the first sound-based communication is received using a microphone of a mobile device and the second sound-based communication is transmitted using a speaker of the mobile device.

13. The method of claim 9, further comprising presenting a message on a graphical user interface of a mobile device inquiring as to whether the payment should be made to the entity.

14. The method of claim 9, further comprising invoking a native application on a device that causes the device to enter a listening mode automatically when the native application is opened, such that the device detects the first sound-based communication when transmitted.

15. The method of claim 9, further comprising:
prior to receiving the first sound-based communication, receiving input associated with the entity from a user; and
adding the input associated with the entity to the plurality of entities in the entity data.

16. A non-transitory computer readable medium comprising logic, the logic when executed by a processor, operable to:
receive a first sound-based communication, wherein the first sound-based communication is received over a local network that is distinct from a general communications network;
determine that the first sound-based communication comprises an entity identifier;
access entity data comprising a plurality of entities;
determine that the plurality of entities comprises an entity associated with the entity identifier;
determine that the entity associated with the entity identifier is authorized to participate in sound-based payment transactions; and
transmit a second sound-based communication authorizing a payment of a payment amount to the entity, wherein the second sound-based communication is transmitted over the local network that is distinct from the general communications network.

17. The computer readable medium of claim 16, wherein the first sound-based communication and the second sound-based communication comprise ultrasonic communications.

18. The computer readable medium of claim 16, the logic further operable to:
receive an update for the entity data via the general communications network; and
store information from the update in the entity data.

19. The computer readable medium of claim 16, wherein the first sound-based communication is received using a microphone of a mobile device and the second sound-based communication is transmitted using a speaker of the mobile device.

20. The computer readable medium of claim 16, the logic further operable to present a message on a graphical user interface of the device inquiring as to whether the payment should be made to the entity.
